(19) United States
(12) Patent Application Publication
(10) Pub. No.: US 2020/0262425 A1
(43) Pub. Date: Aug. 20, 2020

(54) SAFETY-OPTIMIZED NAVIGATION

(71) Applicant: Robert Bosch GmbH, Stuttgart (DE)

(72) Inventor: Evgeniya Ballmann, Stuttgart (DE)

(73) Assignee: Robert Bosch GmbH, Stuttgart (DE)

(21) Appl. No.: 16/061,417

(22) PCT Filed: Oct. 25, 2016
(86) PCT No.: PCT/EP2016/075631

§ 371 Date: Jun. 12, 2018

(30) Foreign Application Priority Data
Dec. 14, 2015 (DE) 102015225152.7

(51) Int. Cl. B60W 30/14; B60W 50/14; G01C 21/34

(52) U.S. Cl. CPC B60W 30/143; B60W 50/14; B60W 2520/06; G01C 21/3469; B60W 2556/50; G01C 21/3461

(57) ABSTRACT

A method for controlling a motor vehicle having an assistance system includes the steps of guiding the motor vehicle with the aid of the assistance system, determining a position of the motor vehicle, determining that the motor vehicle is approaching a location where operational capability of the assistance system could be restricted, and outputting a warning to a driver of the motor vehicle.

### CROSS-REFERENCE TO RELATED APPLICATIONS

The present application is the national stage of International Pat. App. No. PCT/EP2016/075631 filed Oct. 25, 2016, and claims priority under 35 U.S.C. § 119 to DE 10 2015 225 152.7, filed in the Federal Republic of Germany on Dec. 14, 2015, the content of each of which are incorporated herein by reference in their entireties.

### FIELD OF THE INVENTION

The present invention relates to the increasing of safety during guidance of a motor vehicle. In particular, the invention relates to a motor vehicle which is able to be guided with the aid of a driver assist.

### BACKGROUND

A motor vehicle includes a driver assist, which keeps the speed of the motor vehicle at a predetermined level. If the vehicle comes close to a preceding vehicle, the driving speed is then reduced in order to maintain a minimum distance to the preceding vehicle. Such a driver assist is known under the name ACC (Adaptive Cruise Control).

Other driver assists, which can be more or less networked together, can also be available for the motor vehicle. A general engineering goal exists, to design the driver assists in such a way that autonomous guidance of the motor vehicle is possible, that is, that a driver no longer monitors the assistance systems, but rather is able to attend to other tasks, while the assistance systems safely guide the vehicle. One obstacle in the development of such systems is that the operational capability of an assistance system can be reduced sharply under poor external conditions. For example, a radar sensor for determining the distance to a preceding vehicle can deliver incorrect measuring results during heavy precipitation.

### SUMMARY

An object of the present invention is to increase the safety of a motor vehicle that is able to be guided by use of an assistance system. According to a first aspect, a method for controlling a motor vehicle having an assistance system includes the steps of guiding the motor vehicle with the aid of the assistance system, determining a position of the motor vehicle, determining that the motor vehicle is approaching a location where operational capability of the assistance system could be restricted, and outputting a warning to a driver of the motor vehicle. In a further development, a detour around the area in which the operational capability of the assistance system could be restricted can be provided to the driver.

According to a second aspect, a method for controlling a motor vehicle having an assistance system includes the steps of determining a position of the motor vehicle, ascertaining a destination, and determining a route from the current position to the destination. In so doing, the route is determined in such a way that operational capability of the assistance system is maximized to the greatest extent possible.

An idea underlying the present invention is that the operational capability (performance) of an assistance system is often a function of environmental conditions that can already be known even before the vehicle is in an area where these conditions prevail. For example, it can be known that the vehicle is approaching an area in which there is heavy rain, so that the distance sensor from the example above could possibly supply false measured values. It is possible that a rear-end collision cannot be safely avoided under these conditions. This danger can be mitigated by outputting a warning to the driver of the vehicle or determining the route of the vehicle in such a way that it does not pass through the area with the heavy rain. In the first case, the driver can possibly be able to compensate for the reduced performance of the assistance system; in the second case, there is no additional endangerment to the vehicle by the known influences.

According to both aspects, failures of assistance systems can be made less frequent or avoided. The driver can be activated as needed, in order to allow no safety gap to develop owing to a possibly reduced performance of an assistance system. The assistance system can have higher availability. Particularly in the case of semi-automated or autonomous driving, vehicle safety can be increased, or longer contiguous segments of the route can be traveled in semi-automated or automated fashion. On the other hand, takeovers by the driver can be made less frequent. Both methods are suitable to be used with familiar, error-prone assistance systems. Thus, it is not necessary to try to keep the assistance systems functioning perfectly under all conceivable conditions; rather, it can be sufficient to determine limits of the operational capability, and with the aid of one of the methods indicated, to make sure that these limits either are not exceeded or that exceeding them represents no additional risk for the vehicle.

The two methods are able to be combined with various assistance systems. Examples for assistance systems include a left-turning assist, an emergency braking assist, and a dynamic speed control with distance keeping. In particular, the methods are capable of better facilitating semi-autonomous or autonomous driving of the motor vehicle with the aid of one or more assistance systems. In addition, due to the methods, it is possible to increase the safety of the motor vehicle employing an assistance system that functions well only under narrowly defined conditions. It is only necessary to know the limits within which the assistance system functions well.

Preferably, the assistance system is equipped to sense the surroundings of the motor vehicle, the operational capability of the assistance system being determined in terms of the conditions for the sensing. For example, a light-based sensor can be used only poorly at night, a radar sensor or lidar sensor can have a reduced range during heavy precipitation (rain, hail, snow), and a sensor based on radio waves might only operate poorly at certain locations because of signal reflections off of buildings, for instance.

In addition, the assistance system is preferably equipped to aid in a longitudinal or lateral control of the motor vehicle, the operational capability of the assistance system being determined in terms of conditions for influencing the longitudinal or lateral motion of the vehicle.

For instance, an emergency braking assist can realize a shorter braking distance on dry asphalt than on a hard-packed blanket of snow. Every effort could therefore be made to bypass a region with hard-packed snow cover, or a suitable warning can be given to the driver that the emergency braking assist might require a longer braking distance in an upcoming region with hard-packed snow cover.

In the case of the method that includes a route planning, it is preferred that the route be determined in such a way that, in addition, a further criterion of the assistance system is optimized as much as possible. For example, the further criterion can include the minimization of a driving time, the minimization of energy consumption, and/or the minimization of a trip mileage. The various criteria can be weighted, with the driver being able to determine which of the factors should have the greatest influence.

A computer-program product includes program-code for carrying out one of the methods described, when the computer-program product runs on a processing device or is stored on a computer-readable data carrier.

An assistance system includes a sensor for sensing the surroundings of the motor vehicle, an actuator for influencing a longitudinal or lateral motion of the vehicle as a function of the sensing, a positioning device, and a device for determining location-specific circumstances which may alter the performance of the sensing or of the influencing.

In particular, the assistance system can be equipped to carry out one of the methods described above. In various specific embodiments, the assistance system can be designed to output a warning to a driver when the motor vehicle is approaching an area where reduced performance is to be expected, or a route of the vehicle can be planned or altered as a function of such an area.

In an example embodiment, the device for determining location-specific circumstances includes a database having static data. For instance, this data can include tunnels, curves, gradients, average climactic conditions or other parameters that do not change or change only over the long term.

In an example embodiment, the device includes a receiver for dynamic information. For example, the dynamic information can include up-to-date traffic information, climactic conditions or other location-specific information that could have an influence on the performance of the assistance system.

The present invention is described below in greater detail with reference to the accompanying drawings.

### BRIEF DESCRIPTION OF THE DRAWINGS

FIG. 1 shows an assistance system for controlling a motor vehicle according to an example embodiment of the present invention.

FIG. 2 is a flowchart of a method for controlling the motor vehicle from FIG. 1, according to an example embodiment of the present invention.

### DETAILED DESCRIPTION

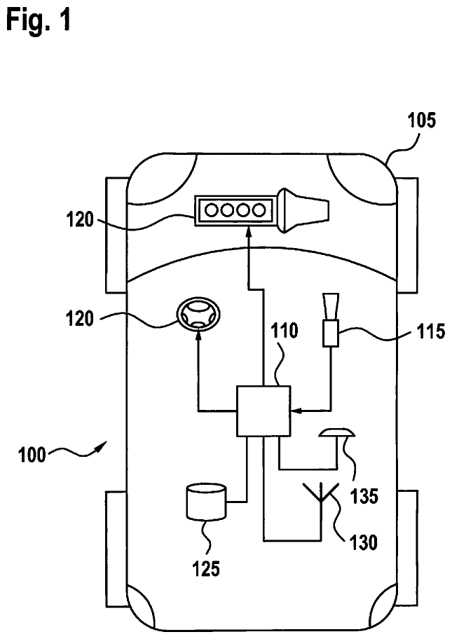

FIG. 1 shows an assistance system 100 for controlling a motor vehicle 105. Assistance system 100 includes a processing device 110 and usually at least one sensor 115 as well as at least one actuator 120. Assistance system 100 is equipped to aid in guiding motor vehicle 105 or, in a further example embodiment, to permit autonomous guidance of motor vehicle 105. To that end, information from an area surrounding motor vehicle 105, especially a section of a route lying in front of motor vehicle 105, is acquired by sensor 115 and processed by processing device 110. A plurality of sensors 115 can also be used. In addition, sensing results or intermediate results of another system can be used, as well, e.g., a speed of motor vehicle 105, a yaw rate, an acceleration, a position, or other static or dynamic driving parameter. In an example embodiment, assistance system 100 is equipped to output a visual, acoustic, or haptic warning to a driver when an undesirable driving condition threatens. For instance, a lane-following assistance system can cause a steering wheel to vibrate, in order to warn the driver that motor vehicle 105 is about to leave a traffic lane. In another example embodiment, assistance system 100 acts on the driving state of motor vehicle 105. In particular, assistance system 100 can influence a longitudinal control or a lateral control of motor vehicle 105. For example, the speed of motor vehicle 105 can be varied by influencing a driving engine or a brake. In corresponding manner, a driving direction of motor vehicle 105 can be controlled by influencing a steering system.

Naturally, assistance system 100 is dependent upon being operated within predetermined system limits, in order to be able to perform its tasks. These system limits can pertain on one hand to the sensing behavior of sensor 115, or on the other hand, to the behavior of one of actuators 120. In addition, assumptions which must be complied with for the processing by processing device 110, can be regarded as system limit. For example, if sensor 115 is to track an object in the area of motor vehicle 105, then the number of objects trackable simultaneously can be predetermined.

Motor vehicle 105 can move in an area in which one or more of the system limits is/are violated.

In a first example, sensing the area surrounding motor vehicle 105 with the aid of a camera-based driving assistance system may be difficult when traveling in a tunnel, because undesirable reflections can interfere with the useful signal. As a result, sensing or tracking an object in the surroundings of motor vehicle 105, e.g., a preceding vehicle, may be unsuccessful.

In a second example, local weather may influence the performance of assistance system 100. For instance, if motor vehicle 105 is traveling through an area of dense fog, a passive optical system (camera) is only poorly able to sense the area surrounding motor vehicle 105. The detection of an object on the basis of such camera images may function poorly so that, for instance, the probability that an emergency braking assist, which is supposed to protect from a collision with pedestrians, will function correctly may be reduced.

In a third example, on a roadway or in an area surrounding motor vehicle 105, there may be objects which possibly are able to be sensed by sensor 115, but which cannot be identified. Predicting the behavior of such objects may therefore prove to be unsuccessful.

It is proposed to ensure the functioning of assistance system 100 by foresightedly determining the areas in which motor vehicle 105 could be traveling, where the operational capability of assistance system 100 could be restricted. In this manner, especially influences caused by error, which may affect various assistance systems 100 (common cause errors), can be reduced. In different specific embodiments, a route can then be planned for motor vehicle 105 in such a way that the doubtful area is bypassed, or a warning can be output to a driver of motor vehicle 105, so that the driver may drive on with heightened attention and reduced aid by assistance system 100.

To determine an area in which reduced operational capability of assistance system 100 pertains, a database 125 can be provided. Database 125 preferably includes static information which changes only very seldom or not at all. In addition or alternatively, a special wireless interface 130 can be provided, via which preferably dynamic information with a high rate of change can be received. In an example embodiment, interface 130 is bi-directional, so that an area which is determined to be functionally restrictive on the part of assistance system 100, can be transmitted wirelessly to a central system or another motor vehicle 105. Data traffic via interface 130 is preferably encrypted.

Optionally, a positioning system 135 can be provided, which can be part of a navigation system. Positioning system 135 is equipped to determine a position of the motor vehicle, namely, preferably with reference to a roadmap with map information that includes a road or highway network.

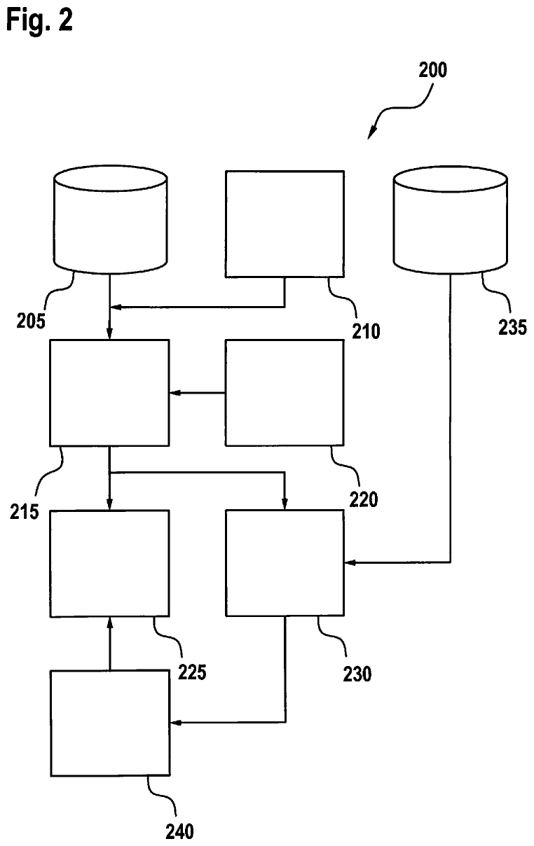

FIG. 2 is a flowchart of a method 200 for controlling motor vehicle 105 from FIG. 1. Method 200 is preferably set up to run on assistance system 100, especially on processing device 110 from FIG. 1. In this context, method 200 can preferably take the form of a computer program product. Method 200 includes a number of steps, which can be executed in different sequences. One skilled in the art will know the variation possibilities and have no difficulty in also providing sequences other than that described below, in order to realize method 200.

In a step 205, information regarding areas which could have a restrictive influence on the performance of assistance system 100 is retrieved from database 125. In corresponding manner, in a step 210, dynamic information is made available with the aid of interface 130. In a step 215, the information of steps 205 and 210 is matched or combined with each other. Thus, for example, missing information can be supplemented or mutual plausibility checks can be carried out. Preferably, this step is implemented with respect to a particular position of motor vehicle 105, which can be determined in a step 220.

Furthermore, it can additionally be checked continuously whether the driver assistance system is functioning under the current conditions. If a certain discrepancy is obtained between the anticipated functionality and a given functionality, the information about the gaps existing in the system can be supplemented. For example, the check can take place in the comparison between the driver actions and the reaction of the systems, or by checking the specific criteria of the object detection, or in some other way.

In an example embodiment, steps 205 and 210 are also carried out in terms of the position of motor vehicle 105 or in terms of a planned route. The comparison between the particular position or the planned route and the specific areas which could have a restrictive effect on the performance of assistance system 100 can result in no match, so that the motor vehicle can continue to travel without restrictions. A localized match can also be determined if the route leads through an area where a restriction of the performance of assistance system 100 is to be expected. In this case, the route can be altered in such a way that to the greatest extent possible, no such area is traveled through. If this is not possible, the number of areas driven through, the length of the route which leads through such areas, or the degree of adverse influence can be minimized to the greatest possible extent.

In a step 225, a warning can be output to a driver of motor vehicle 105 if motor vehicle 105 is approaching an area or a location where the operational capability of assistance system 100 could be restricted, or if motor vehicle 105 is already in such an area. This warning can be provided acoustically, visually, and/or haptically. Alternatively or additionally, a suggestion for avoiding the questionable area can be determined and offered.

Independently, in a step 230, a route can be determined which avoids as much as possible one or more areas where the operational capability of assistance system 100 could be restricted. In particular, the route can be determined as a function of map information, which in a step 235, can be provided especially from a database 125. In an example embodiment, the route between the current position and a destination is determined in such a way that the safety of motor vehicle 105 is maximized, thus, as few restrictions as possible are to be feared for the performance of assistance system 100 on the route. In addition, the route can also be determined in terms of another criterion, e.g., a shortest connection or a fastest journey. Several destination criteria can also be adopted, it being preferred that the preservation of the safety of motor vehicle 105 have the greatest influence among the destination criteria.

One or more alternatively determined routes can be offered to a driver of motor vehicle 105 for selection. The driver may decide on one of the routes, or may take a different route at the driver's own discretion.

In a step 240, motor vehicle 105 drives, preferably on one of the determined routes, with the aid of assistance system 100. Should motor vehicle 105 approach an area where the performance of assistance system 100 is restricted, then in step 225, a warning can be output to the driver. This can even be done if the route of motor vehicle 105 has been optimized in terms of minimizing the restriction of the operational capability of assistance system 100. In addition, the driver can be asked whether the driver wants to bypass the area, and a detour for the area can be offered to the driver.

1-9. (canceled)

10. A method for controlling a motor vehicle, the method comprising:
guiding the motor vehicle using an assistance system of the motor vehicle;
determining a position of the motor vehicle;
determining that the motor vehicle is approaching a location where operational capability of the assistance system could be restricted; and
responsive to the determination of the approach, outputting a warning to a driver of the motor vehicle.

11. The method of claim 1, wherein the assistance system is equipped to sense surroundings of the motor vehicle, and the operational capability includes ability to sense.

12. The method of claim 1, wherein the assistance system is equipped to aid in a control of a longitudinal or lateral motion of the motor vehicle, and the operational capability includes an ability to influence the longitudinal or lateral motion of the motor vehicle.

13. A method for controlling a motor vehicle, the method comprising:
determining a position of the motor vehicle;
ascertaining a destination; and
determining a route from the current position to the destination by which operational capability of an assistance system of the motor vehicle is maximized.

14. The method of claim 2, wherein the assistance system is equipped to sense surroundings of the motor vehicle, and the operational capability includes ability to sense.

15. The method of claim 2, wherein the assistance system is equipped to aid in a control of a longitudinal or lateral motion of the motor vehicle, and the operational capability includes an ability to influence the longitudinal or lateral motion of the motor vehicle.

16. The method of claim 2, wherein the determination of the route is determined so that the route minimizes at least one of a driving time, an energy consumption, and a trip mileage.

17. A non-transitory computer-readable medium on which are stored instructions that are executable by a processor and that, when executed by the processor, cause the processor to perform a method for controlling a motor vehicle, the method comprising:
guiding the motor vehicle using an assistance system of the motor vehicle;
determining a position of the motor vehicle;
determining that the motor vehicle is approaching a location where operational capability of the assistance system could be restricted; and
responsive to the determination of the approach, outputting a warning to a driver of the motor vehicle.

18. A non-transitory computer-readable medium on which are stored instructions that are executable by a processor and that, when executed by the processor, cause the processor to perform a method for controlling a motor vehicle, the method comprising:
determining a position of the motor vehicle;
ascertaining a destination; and
determining a route from the current position to the destination by which operational capability of an assistance system of the motor vehicle is maximized.

19. An assistance system comprising:
a sensor for sensing surroundings of a motor vehicle (105);
an actuator for influencing a longitudinal or lateral motion of the motor vehicle based on the sensing;
a positioning device; and
a device configured to determine, based on a position determined by the positioning device, presence of location-specific circumstances that are able to alter a performance of the sensing or of the influencing.

20. The assistance system of claim 19, wherein the device includes a database of static data.

21. The assistance system of claim 19, wherein the device includes a receiver for dynamic information.
